(19) United States
(12) Patent Application Publication
(10) Pub. No.: US 2011/0055606 A1
(43) Pub. Date: Mar. 3, 2011

(54) COMPUTER SYSTEM, INTEGRATED CHIP, SUPER IO MODULE AND CONTROL METHOD OF THE COMPUTER SYSTEM

(76) Inventors: Meng-Chyi WU, Hsinchu County (TW); Shih-Hsin Su, Taoyuan County (TW)

(21) Appl. No.: 12/547,003

(22) Filed: Aug. 25, 2009

(51) Int. Cl. G06F 1/32; G06F 13/14

(52) U.S. Cl. 713/323; 710/305

(57) ABSTRACT

A computer system including a wireless module and a super IO module is provided. The wireless module communicates with a mobile device to detect whether the mobile device is within a predetermined distance to the computer system. The super IO module electrically coupled to the wireless module manages the status of the computer system based on the distance of the mobile device. If the mobile device moves away from the range of the predetermined distance, the super IO module sends a first management signal to switch the computer system to an inactive state. Conversely, if the mobile device moves into the range of the predetermined distance while the computer system is in an inactive status, the super IO module sends a second management signal to switch the computer system back to a normal operation status or power up the computer system.

### BACKGROUND OF THE INVENTION

1. Field of the Invention

The invention relates to computer resource management, and in particular, to access privilege control of a computer system based on user location.

2. Description of the Related Art

Availability of public computer use is increasing. In offices, schools, commercial establishments and internet cafes, computers are always used by numerous users. The computer can be used by multiple users at home too. Under such circumstances, computer resource management issue becomes important. For example, the electricity is wasted if a user leaves a computer on when the computer is not used. Additionally, if a user locks a computer console on a public computer, the next user may have trouble accessing the locked console. Furthermore, user passwords or private information may be made available to following users, if proper steps for security are not taken by a user on a public computer.

Restricting user privileges to public computers is one of conventional computer resource management method. Additionally, for public computers in schools, an implant recovery mechanism may be applied. Thus, once the public computer is rebooted, the system is automatically recovered to its initial state that resets every modification made by a previous user, and all the occupied computer resources would be released and available for a next user. However, the recovery mechanism does not reduce electricity consumption if the computer is unoccupied. Moreover, by automatically resetting the system, permanent data loss of the original user may not be a desired outcome.

### BRIEF SUMMARY OF THE INVENTION

An embodiment of a computer system is provided. In the computer system, a wireless module detects whether a mobile device is within a range of a predetermined distance to the computer system. A super Input/Output (IO) module is electrically coupled to the wireless module, managing the computer system's status based on the detection performed by the wireless module. When the mobile device moves away from the range of the predetermined distance, the super IO module sends a first management signal to switch the computer system to an inactive status. When the mobile device moves into the range of the predetermined distance while the computer system is in the inactive status, the super IO module sends a second management signal to switch the computer system back to a normal operation status or power up the computer system.

An embodiment of a control method adaptable for a computer system is provided. A wireless module and a super IO module are provided. The wireless module detects whether a mobile device is within a range of a predetermined distance to the computer system. When the mobile device moves away from the range of the predetermined distance, the super IO module sends a first management signal to switch the computer system to an inactive status. When the mobile device moves into the range of the predetermined distance while the computer system is in the inactive status, the super IO module sends a second management signal to switch the computer system back to a normal operation status.

An embodiment of an integrated chip (IC) adaptable in a computer system is provided. The IC comprises a power control pin electrically coupled to a power module in the computer system for controlling a power status of the computer system, a wireless module detecting whether a mobile device is within a range of a predetermined distance to the computer system, and a controller electrically coupled to the wireless module and the power control pin. When the mobile device moves away from the range of the predetermined distance, the controller sends a first power management signal to direct the power module to switch the computer system to an inactive status. When the mobile device moves into the range of the predetermined distance while the computer system is in the inactive status, the controller sends a second power management signal to direct the power module to switch the computer system back to a normal operation status or power up the computer system.

An embodiment of a super IO module for controlling serial ports, parallel ports, PS/2 ports, and a keyboard control module in the computer system, comprising a wireless module and a controller, is provided. The wireless module detects whether a mobile device is within a range of a predetermined distance to the computer system. The controller is electrically coupled to the wireless module. When the mobile device moves away from the range of the predetermined distance, the controller disables the serial ports, the parallel ports, the PS/2 ports and the keyboard control module. When the mobile device moves into the range of the predetermined distance, the controller enables the serial ports, the parallel ports, the PS/2 ports, and the keyboard control module.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an embodiment of a computer system according to the invention; and

FIG. 2 is a flowchart of the control method described in one embodiment according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The embodiments of the invention assume the following premise: that a computer is safe if a user is nearby, otherwise, a security mechanism must be imposed. Following, a computer and a control method thereof of the invention will be described.

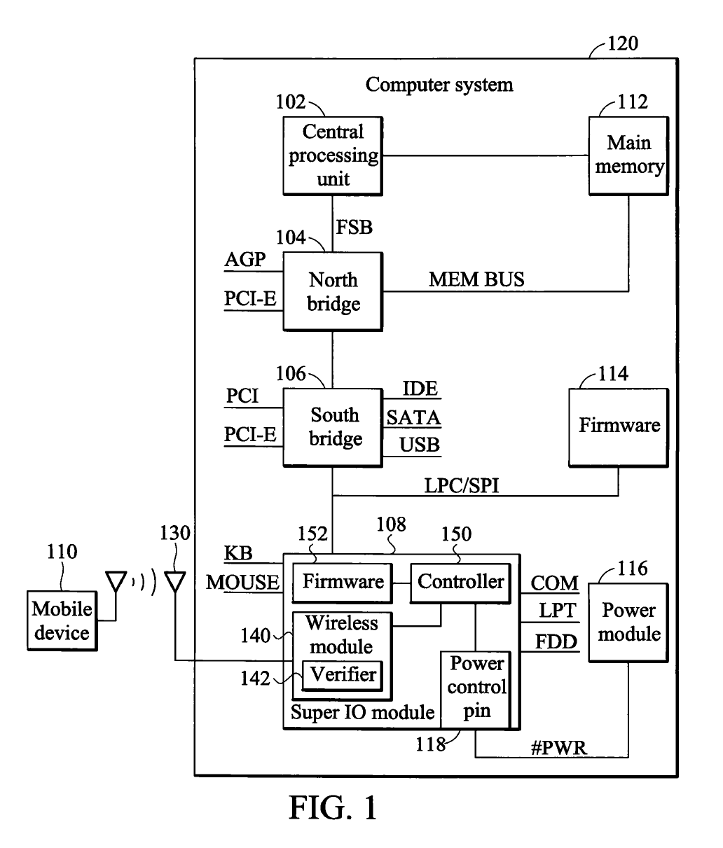

FIG. 1 shows an embodiment of a computer system according to the invention. A computer system 120 substantially comprises a central processing unit 102, a north bridge 104, a south bridge 106, a main memory 112 and a firmware 114 each serving different functions. Since the structure of a computer system 120 is generally known to those skilled in the art, detailed description is omitted herein.

In the embodiment, the computer system 120 can communicate with a mobile device 110. Since a mobile device 110 is usually carried by an owner, the presence of the mobile device 110 represents the presence of the owner. The computer system 120 comprises a wireless module 140, receiving and transmitting wireless signals through an antenna 130 to communicate with the mobile device 110. Thus, the wireless module 140 can detect whether the computer system 120 is within a range of a predetermined distance. The wireless module 140 can be an infrared transmission module, and radio frequency identification (RFID) module, a Bluetooth module, or even a magnitude card sensor. The mobile device 110 can be a wireless module having a certificate, such as a Bluetooth mobile phone, an infrared remote controller, an RFID card or a magnitude card. Distance detection can be actively implemented by the wireless module 140 by broadcasting beacon signals and listening echoes, or passively implemented by waiting for receiving the wireless signal sent from the mobile device 110. Note that Bluetooth follows a broadcast standard, and the RFID is a non-contact sensing mechanism. Various detection technologies are applicable in the embodiment.

The wireless module 140 can comprise a verifier 142, and the mobile device 110 has a certificate (not shown). The certificate can comprise authorization information that can be identified by the verifier 142 to determine whether its owner has access privilege to the computer system 120. The access privilege can be a list of allowed/disallowed applications, or permissions to use peripheral devices such as a keyboard, a mouse, a CD-ROM driver, and a floppy disk driver.

Referring to FIG. 1, the computer system 120 can comprise a super IO module 108. The super IO module 108 is electrically coupled to the wireless module 140, the south bridge 106, and the power module 116. Specifically, the super IO module 108 can comprise a controller 150. The wireless module 140 can be integrated as a subunit in the super IO module 108. Thus, the super IO module 108 can control the status of computer system 120 according to the distance detection performed by the wireless module 140. In a further embodiment, the super IO module 108 can further comprise a firmware 152 coupled to the controller 150 and adapted to support the controller 150 by performing status switching processes for the computer system 120.

For example, when the mobile device 110 is beyond the range of the predetermined distance to the computer system 120, the super IO module 108 can send a first management signal to switch the computer system 120 to an inactive status. When the mobile device 110 moves into the range of the predetermined distance while the computer system 120 is in the inactive status, the super IO module 108 can send a second management signal to switch the computer system 120 back to a normal operation status or power up the computer system 120. The inactive status can be a standby status, a sleeping status or a powered off status. The normal operation status mentioned herein, as opposite to the inactive status, can be just a restored status from the standby status or sleeping status, or a cold start/restart of an unpowered computer.

Particularly, the first and second management signals are power management signals. The super IO module 108 has a power control pin 118 for outputting the power management signal #PWR to the power module 116, which is electrically coupled to the power control pin 118. The power control pin 118, specifically, can be a PS-ON pin as defined in the Advance Technology Extended (ATX) standard, and the power module 116 following the ATX standard, changes the power status of the computer system 120 in response to the power management signal #PWR passed through the PS-ON pin. In the embodiment, the super IO module 108 has a controller 150 for generating the first and second power management signals. Furthermore, a firmware 152 can be included in super IO module 108 and adapted to support the controller to power up the computer system or switch the computer system 120 to an inactive status or back to a normal operation status.

The super IO module 108 can operate independently without being controlled by the operating system or software of the computer system 120. For example, when the computer system 120 is powered off, the central processing unit 102, south bridge 106 and north bridge 104 are also shutdown, but the super IO module 108 can still keep operating to sense the presence of the mobile device 110. When a mobile device 110 moves into the range of the predetermined distance, the controller 150 in the super IO module 108 is triggered to deliver a power management signal #PWR to the power module 116, directing the computer system 120 to power up.

In another embodiment, the first and second management signals initiated from the super IO module 108 can be sent to the central processing unit 102 through the south bridge 106. Upon being triggered by the management signals, the central processing unit 102 can execute certain driver programs (not shown) to power up the computer system 120 or change the status of the computer system 120, such as switching from an inactive status to normal operation status, or vice versa.

In another embodiment, the super IO module 108 can be connected to the south bridge 106 and firmware 114 through a Low Pin Count (LPC) bus or a Serial Peripheral Interface (SPI) bus. The firmware 114, for example, can be the Basic Input/Output System (BIOS). The super IO module 108 can be controlled by the firmware 114 to perform to a status switching procedure that generates the first or second management signal to change the status of the computer system 120.

A particular example is provided to better describe the invention. The wireless module 140 continuously senses the presence of the mobile device 110. If the presence of the mobile device 110 goes from a detectable status to be undetectable, it is assessed that the mobile device 110 is moved out from the effective range of the predetermined distance. In such a circumstance, the super IO module 108 sends a management signal (such as power management signal #PWR) to the power module 116 to trigger an Advanced Configuration and Power Interface (ACPI) mechanism that can switch the computer system 120 to an inactive status. If the predetermined distance is 10 meters, that means the computer system 120 can remain active while a user is within a 10 meter distance. The predetermined distance may also be defined to have a stricter range, such as 1 or 2 meters.

Meanwhile, if the presence of the mobile device 110 goes from undetectable to being detected, it is assessed that the mobile device 110 is approaching, and if the computer system 120 is inactive, the super IO module 108 may immediately send a power management signal #PWR to the power module 116 to trigger the ACPI mechanism that can power up the computer system 120. The inactive status mentioned above may be variably defined by the operating system, driver program or firmware, to a status such as sleeping, standby or powering off status when a power control pin (e.g PS-ON) is triggered. Thus relevant applications of status changing/switching are not limited in the embodiment.

Through the embodiments of the super IO module 108 and the wireless module 140, the computer system 120 can be switched from a power off state to a power on state, and vice versa. Furthermore, the wireless module 140 can verify validity of the certificate carried on the mobile device 110 to implement further security controls. For example, the wireless module 140 can comprise a verifier 142 for determining whether to grant access privileges (such as a list of allowed or disallowed applications) to the owner of the mobile device 110. If the certificate does not pass the verification, the controller 150 in the super IO module 108 would not send any power management signal #PWR to the power module 116. Additionally, the certificate can be adapted as a ticket for use with shared public computers. For example, one particular certificate may be granted for use with one particular computer.

Further, referring FIG. 1, the super IO module 108 is dedicated to control peripheral devices such as PS/2 ports, serial ports, parallel ports, game ports, floppy drivers, and a keyboard control module. Thus, in one embodiment, the super IO module 108 can partially or fully implement permission control on the peripheral devices based on the presence detection of mobile device 110 performed by the wireless module 140. For example, if the mobile device 110 is moved out from the range of the predetermined distance, the controller 150 in the super IO module 108 can disable the PS/2 ports, serial ports, parallel ports, or/and the keyboard control module. Conversely, when the mobile device 110 moves into the range of the predetermined distance, those disabled peripheral devices may be enabled again. While the peripheral devices are disabled, the audio and video functions may not be affected, thus the computer system 120 may keep operating to output video and sounds. Such an approach is particularly adequate to public demonstrations or exhibitions where any unauthorized input to the computer system 120 is unwanted. The wireless module 140 can also be implemented in the super IO module 108 to form a single integrated chip.

Since the super IO module 108 controls input devices such as a keyboard and a mouse, it is possible to implement a further embodiment as follows. For example, if the mobile device 110 moves into the range of the predetermined distance, the super IO module 108 can generate a simulated keyboard input string as if it was input through the keyboard (not shown), making the computer system 120 switch back to normal operation status from the inactive status. The simulated keyboard input string may serve as a password to unlock a console lock that requires the password. The keyboard control module (not shown) may be directly connected to the wireless module 140, reacting directly in response to the detection results from wireless module 140. The simulated keyboard input string can be predefined and stored in the firmware 114.

The aforementioned various functions can be combined together. For example, when the mobile device 110 leaves an effective range, the computer system 120 does not have to immediately switch to the standby or power off status, instead, it may lock the console or logout of the operating system. Following, when the console lock or logout status is sustained for a predetermined period of time, the super IO module 108 can further send a power management signal #PWR to switch the computer system 120 into the sleeping status, the standby status or the power off status.

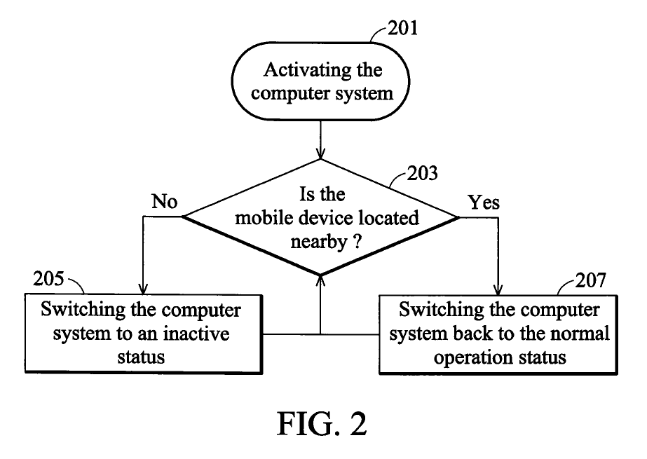

The aforementioned embodiments are summarized in a flowchart as shown in FIG. 2. In step 201, the computer system 120 is activated. In step 203, the wireless module 140 detects whether the mobile device 110 is located nearby the computer system 120. If the wireless module 140 fails to sense the presence of mobile device 110, the mobile device 110 is assessed as being out of range, and step 205 is processed to switch the computer system 120 to an inactive status.

In the embodiments, the inactive status is generally referred to as any limited status function such as console lock, logout, standby or powered off status. If in the step 203, the presence of mobile device 110 is sensed, with a certificate having valid privileges, step 207 is processed, wherein the computer system 120 is switched back to the normal operation status from the inactive status. Further in step 203, if the mobile device 110 is valid and the owner of the mobile device 110 is different from a previous user, step 207 further includes a logout process to logout the previous user, such that privacy of each user can be ensured.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer system, comprising:
a wireless module, communicating with a mobile device and detecting whether the mobile device is within a range of a predetermined distance to the computer system; and
a super Input/Output (IO) module, electrically coupled to the wireless module, managing the computer system's status based on the detection performed by the wireless module;
wherein when the mobile device moves away from the range of the predetermined distance, the super IO module sends a first management signal to switch the computer system to an inactive status, and
when the mobile device moves into the range of the predetermined distance while the computer system is in the inactive status, the super IO module sends a second management signal to switch the computer system back to a normal operation status or power up the computer system.

2. The computer system as claimed in claim 1, wherein the inactive status is a standby, sleeping or powered off status of the computer system.

3. The computer system as claimed in claim 1, further comprising a power module, electrically coupled to a power control pin on the super IO module, for controlling a power status of the computer system, wherein the first management signal and the second management signal are power management signals transmitted through the power control pin to the power module.

4. The computer system as claimed in claim 1, further comprising a central processing unit and a driver program, the central processing unit receiving the first management signal or the second management signal, and executing the driver program to switch the computer system's status according to the first or second management signal.

5. The computer system as claimed in claim 4, wherein the wireless module comprises a verifier, for verifying a certificate in the mobile device, and the super IO module determines whether to grant an access privilege of the computer system to the user possessing the mobile device according to the verification of the certificate, and the access privilege comprises a list of allowed applications and disallowed applications.

6. The computer system as claimed in claim 1, wherein the super IO module further comprises a keyboard control module, and when the mobile device moves into the range of the predetermined distance, the super IO module directs the keyboard control module to generate a simulated keyboard input string that commands the computer system to switch back to the normal operation status from the inactive status.

7. The computer system as claimed in claim 6, further comprising a serial port, a parallel port, a PS/2 port, a game port and a floppy port, the inactive status denoting a status that the serial port, the parallel port, the keyboard control module and the PS/2 port are disabled, and the video and audio are continuously output from the computer system.

8. A control method adaptable for a computer system, comprising:
providing a wireless module and a super IO module in the computer system;
detecting whether a mobile device is within a range of a predetermined distance to the computer system by the wireless module;
when the mobile device moves away from the range of the predetermined distance, the super IO module sends a first management signal to switch the computer system to an inactive status; and
when the mobile device moves into the range of the predetermined distance while the computer system is in the inactive status, the super IO module sends a second management signal to switch the computer system back to a normal operation status.

9. The control method as claimed in claim 8, wherein the inactive status is a standby, sleeping or powered off status of the computer system.

10. The control method as claimed in claim 8, further comprising verifying a certificate in the mobile device to determine whether to grant an access privilege of the computer system to the user possessing the mobile device, and the access privilege comprises a list of allowed applications and disallowed applications.

11. An integrated chip adaptable in a computer system, comprising:
a power control pin, electrically coupled to a power module in the computer system, for controlling a power status of the computer system;
a wireless module, detecting whether a mobile device is within a range of a predetermined distance to the computer system; and
a controller, electrically coupled to the wireless module and the power control pin;
wherein when the mobile device moves away from the range of the predetermined distance, the controller sends a first power management signal to direct the power module to switch the computer system to an inactive status, and
when the mobile device moves into the range of the predetermined distance while the computer system is in the inactive status, the controller sends a second power management signal to direct the power module to switch the computer system back to a normal operation status or power up the computer system.

12. The integrated chip as claimed in claim 11, wherein the inactive status is a standby, sleeping or powered off status of the computer system.

13. The integrated chip as claimed in claim 11, wherein the wireless module is infrared transmission module, a radio frequency identification (RFID) module, or Bluetooth module.

14. The integrated chip as claimed in claim 13, wherein the wireless module comprises a verifier, for verifying a certificate in the mobile device, and the controller determines whether to grant an access privilege of the computer system to the user possessing the mobile device according to the verification of the certificate, and the access privilege comprises a list of allowed applications and disallowed applications.

15. The integrated chip as claimed in claim 14, wherein the controller does not issue the first or the second power management signal if the verifier finds the certificate invalid.

16. The integrated chip as claimed in claim 15, wherein the power control pin is a PS-ON pin compliant with the Advanced Technology Extended (ATX) standard.

17. The integrated chip as claimed in claim 16, further comprising a keyboard control module electrically coupled to the wireless module, wherein:
when the mobile device moves into the range of the predetermined distance while the computer system is in the inactive status, the keyboard control module sends a first simulated input string to switch the computer system back to a normal operation status; and
when the mobile device moves away from the range of the predetermined distance, the keyboard control module sends a second simulated input string to switch the computer system into a console locked status or a logged out status.

18. The integrated chip as claimed in claim 17, wherein the inactive status is a console locked status, and the first simulated input string is a predetermined password for unlocking the console.

19. The integrated chip as claimed in claim 11, further comprising a firmware electrically coupled to the controller, programmed to power up the computer system or to perform a status switching procedure that switches the computer system into the inactive status or back to the normal operation status.

20. A super IO module, adaptable in a computer system, for controlling serial ports, parallel ports, PS/2 ports, and a keyboard control module in the computer system, wherein the improvement comprises:
a wireless module, detecting whether a mobile device is within a range of a predetermined distance to the computer system; and
a controller, electrically coupled to the wireless module, wherein:
the controller disables the serial ports, the parallel ports, the PS/2 ports and the keyboard control module when the mobile device moves away from the range of the predetermined distance, and
the controller enables the serial ports, the parallel ports, the PS/2 ports, and the keyboard control module when the mobile device moves into the range of the predetermined distance.
